(19) United States
(12) Patent Application Publication
(10) Pub. No.: US 2023/0108610 A1
(43) Pub. Date: Apr. 6, 2023

(54) SYSTEMS FOR SECURE DATA REPLICATION AND ORIGINAL DESTRUCTION USING A BLOCKCHAIN DISTRIBUTED LEDGER

(71) Applicant: c/o NIFTY CONCEPTS LLC, Holland, OH (US)

(72) Inventors: Victor W. Tang, Clyde Hill, WA (US); Phillip S. Runyan, Holland, OH (US)

(21) Appl. No.: 17/959,906

(22) Filed: Oct. 4, 2022

Related U.S. Application Data
(60) Provisional application No. 63/252,160, filed on Oct. 5, 2021.

(51) Int. Cl. G06Q 20/36; H04L 9/00; G06Q 20/40; G06Q 20/38

(52) U.S. Cl. CPC G06Q 20/3672; H04L 9/50; G06Q 20/401; G06Q 20/3825; G06Q 2220/00

(57) ABSTRACT

Systems and methods for secure data replication and original destruction using a blockchain distributed ledger include program instructions to generate an NFT on a secondary blockchain platform in response to receiving a request to transfer an existing NFT from an original blockchain platform to the secondary blockchain platform, the generating including accessing a smart contract deployed on the secondary blockchain platform and is configured to execute a mint function. The program instructions execute the mint function of the smart contract, the executing including copying existing NFT data of the existing NFT from the original blockchain platform to the generated NFT, and store on the secondary blockchain: (i) a pointer to identify the existing NFT of the original blockchain platform and a transaction hash associated with a most recent transaction involving the existing NFT. The program instructions transmit the generated NFT to a digital wallet of the secondary blockchain platform.

### CROSS-REFERENCE TO RELATED APPLICATIONS

This application claims priority benefit of U.S. Provisional Patent Application No. 63/252,160, filed on Oct. 5, 2021, and entitled Interoperability of Non-Fungible Tokens, the entire contents of which is hereby expressly incorporated herein by reference in its entirety.

### FIELD OF THE INVENTION

This invention relates generally to non-fungible tokens (NFTs), and more particularly, embodiments of the invention relate to the use of a computing system to effectuate cross-chain, blockchain transactions.

### BACKGROUND OF THE INVENTION

Blockchain is a peer-to-peer, electronic ledger that includes a chain of blocks of data, where each block includes one or more transactions. Each transaction points back to a preceding transaction in a sequence, which may span one or more blocks. Blockchain-based content engagement platforms may include a registry services that enable verified content creators to mint NFTs. NFTs can be created for a large range of real world media content and intellectual property including artwork and collectibles. NFTs can have multifunctional programmable use cases including private access to premium content and experiences.

NFTs evolved from the Ethereum Request for Comments 721 (ERC-721) standard that implements an application programming interface (API) for tokens within smart contracts, where the token is unique and can have a different value than another token from the same smart contract. NFTs allow for the transfer of tokens from one user account to another. A smart contract is a computer program designed to automate the execution of the terms of a machine-readable contract or agreement, where the terms of the smart contract can cause inputs to be processed that generate results with subsequent actions being performed that are dependent upon the generated results.

The marketplace for minting and selling NFTs has blossomed in the last few years and has predominantly been active on the Ethereum blockchain. Although the Ethereum blockchain has been the predominant blockchain used for NFT transactions, numerous concerns have arisen over the use of the Ethereum blockchain. In particular, concerns with Ethereum blockchain have arisen related to the cost, carbon footprint, performance bottlenecks, and security. As a result, there is a growing market for NFTs that are created on other blockchains. Having multiple blockchains that support NFTs poses a challenge for an NFT creator to decide which blockchain to adopt when creating an NFT since the marketplace is dominated by the Ethereum blockchain. Additional challenges arise for owners of NFTs that were minted on the Ethereum blockchain that would rather use other blockchain platforms.

### BRIEF SUMMARY

Shortcomings of the prior art are overcome and additional advantages are provided through the provision of a computing system for secure data replication and original destruction using a blockchain distributed ledger. The system includes a memory, one or more processors in communication with the memory, and program instructions executable by the one or more processors via the memory to generate a non-fungible token (NFT) on a secondary blockchain platform in response to receiving a request to transfer an existing NFT from an original blockchain platform to the secondary blockchain platform. The generating includes accessing a smart contract that is deployed on the secondary blockchain and is configured to execute a mint function. The program instructions also execute the mint function of the smart contract, the executing including copying existing NFT data of the existing NFT from the original blockchain platform to the generated NFT. Further, the program instructions store on the secondary blockchain (i) a pointer to identify the existing NFT of the original blockchain platform, and (ii) a transaction hash associated with a most recent transaction involving the existing NFT. Additionally, the program instructions transmit the generated NFT to a digital wallet of the secondary blockchain.

Additionally, disclosed herein is a computing system for secure data replication and original destruction using a blockchain distributed ledger, where the system includes a memory, one or more processors in communication with the memory, and program instructions executable by the one or more processors via the memory. Execution of the program instructions activates a login module configured to process authorization data, and receives user-specific authorization data. Further, execution of the program instructions processes the user-specific authorization data to access one or more user accounts associated with the user-specific authorization data, and accesses a digital wallet of a user account of the one or more user accounts, wherein the digital wallet is connected to a blockchain that is in communication with a conversion module that is accessible via the user account.

A computer-implemented method for secure data replication and original destruction using a blockchain distributed ledger is also provided herein. The computer-implemented method includes generating a non-fungible token (NFT) on a secondary blockchain platform in response to receiving a request to transfer an existing NFT from an original blockchain platform to the secondary blockchain platform, where the generating includes accessing a smart contract that is deployed on the secondary blockchain platform and is configured to execute a mint function. Further, the method includes executing the mint function of the smart contract, where the executing includes copying existing NFT data of the existing NFT from the original blockchain platform to the generated NFT. Additionally, the method includes storing on the secondary blockchain platform (i) a unique identifier of the existing NFT that is on the original blockchain platform, and (ii) a transaction hash associated with an escrow transfer of the existing NFT. Also, the generated NFT is transmitted to a digital wallet of the secondary blockchain platform.

Additional features and advantages are realized through the concepts described herein.

### BRIEF DESCRIPTION OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 depicts an example computing environment that includes two blockchain node networks, according to an implementation of the present disclosure;

FIG. 2 depicts a block diagram of an example computing system for secure data replication and original destruction using a blockchain distributed ledger, according to an implementation of the present disclosure;

FIG. 3 depicts an example user interface visible via a computing device, according to an implementation of the present disclosure;

FIG. 4 depicts a block diagram of an example transaction via a conversion module, according to an implementation of the present disclosure;

FIG. 5 depicts a flowchart of an example method for secure data replication using a blockchain distributed ledger, according to an implementation of the present disclosure;

FIG. 6 a flowchart of an example method for processing user-specific authorization data for secure data replication and original destruction, according to an implementation of the present disclosure;

FIG. 7 depicts a flowchart of an example method of transferring a NFT created on an original blockchain platform to a secondary blockchain platform, according to an implementation of the present disclosure; and

FIG. 8 depicts a block diagram of an example transaction via a conversion module of a third-party NFT conversion service, according to an implementation of the present disclosure.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

As described herein, the term “blockchain” includes all forms of electronic, computer-based distributed ledgers such as, for example, consensus-based blockchain and transaction-chain technologies, permissioned and unpermissioned ledgers, shared ledgers and variations thereof. Example blockchain-based networks may include a logical structure of blocks chained together by, for example, cryptographic hash pointers and each block may include a header that provides verification of data recorded in the specific block as well as from prior blocks in the chain. Specific blockchain platforms such as Bitcoin or Ethereum may be referred to herein as non-limiting examples for the purposes of convenience and illustration and various alternative blockchain platforms (e.g., Bitcoin SV, Hyperledger, Cardano, Neo, etc.) are within the scope of the present disclosure.

As described herein, the term “non-fungible token (NFT)” refers to any cryptographic asset having unique identification codes and metadata that make the asset individually distinguishable. NFTs are not mutually interchangeable and each NFT represents a unique cryptographic asset. Generally, an NFT is created via a cryptographic transaction process that provides a digital signature that tracks NFT ownership. This digital signature provides a public proof of ownership or certificate of authenticity to owners of an NFT. The digital signature allows for verifiable transferability from one owner to another, and sales or trades of NFTs has become increasingly popular. Typical NFTs may include art, music, trading cards, signatures, memes, collectables, and the like. A non-limiting example of NFTs include NFTs minted under the ERC721 and ERC1155 standard on EVM blockchains, but any NFT such as NFTs that are not Ethereum-based may also be used.

As described herein, a “smart contract” is a computer program that is capable of automating execution of the terms of a machine-readable contract based on rules that can process inputs in order to produce results, which can cause actions to be performed that are dependent on these results. Generally, smart contracts are used in the transfer of property rights or assets including, for example, digital assets such as NFTs. In particular, each NFT may be associated with a programmatically defined smart contract written to a respective blockchain ledger. According to various embodiments described herein, the smart contracts may include specified fee distribution obligations, such as licensing royalties, that are recorded in the blockchain. A non-limiting example of smart contracts include smart contracts may be associated with NFTs minted under ERC721 and ERC1155 standards on EVM chains, but smart contracts associated with NFTs minted via other blockchains may also be used.

Disclosed herein are systems and methods for converting and transferring an NFT from an original blockchain platform to a facsimile on another secondary blockchain platform while maintaining verifiable transferability of the NFT. In particular, the verifiable transferability is maintained by deactivating or burning the original NFT from the original blockchain platform and recording the transfer in a single ledger that includes a record of all transactions across all blockchains. According to one embodiment, the ledger could also be maintained on one of the referenced blockchains (e.g., the secondary blockchain platform). Advantageously, the disclosed systems and methods allow for transferability of NFTs from one blockchain to another, while providing verifiable proof of authenticity and provenance of the NFT. Such transferability may enable an owner or purchaser of an NFT to use a preferred blockchain.

As disclosed herein, the terms “mint,” “minted,” “minting,” and the like refer to a process of generating of digital assets on a blockchain. In particular, a token (e.g., a NFT) is minted when digital data is converted into a digital asset and recorded/stored in a blockchain.

As disclosed herein the terms “burn,” “burned,” “burning,” and the like refer to a process where a token (e.g., a NFT) can be sent to a burn wallet or null/eater address, which is a cryptographic wallet that is only capable of receiving tokens but not sending tokens. The “burning” process ensures that the token is effectively locked and taken out of circulation, which is often referred to as destroying the token. The “burning” transaction is confirmed on the blockchain ledger, which ensures that the “burn” is permanent and irrevocable.

In particular, disclosed herein is a computing system for secure data replication and original destruction using a blockchain distributed ledger. The system includes a memory and one or more processors in communication with the memory. The system also includes program instructions that are executable by the one or more processors via the memory. Execution of the program instructions generates a non-fungible token on a secondary blockchain platform in response to receiving a request to transfer an existing NFT from an original blockchain platform to the secondary blockchain platform. Further, the generating includes accessing a smart contract configured to execute a mint function.

Additionally, executing the program instructions includes executing the mint function of the smart contract, where the executing includes copying existing NFT data of the existing NFT from the original blockchain platform to the generated NFT. Execution of the program instructions also includes storing on the secondary blockchain platform (i) a pointer to identify the existing NFT of the original blockchain platform, and (ii) a transaction hash associated with a most recent transaction involving the existing NFT. In particular, the most recent transaction of the stored transaction hash identifies a transfer transaction of the existing NFT to a system escrow account on the secondary blockchain platform. Execution of the program instructions also includes transmitting the generated NFT to a digital wallet of the secondary blockchain platform.

By creating a method to convert and transfer an NFT from blockchain X to a facsimile on blockchain Y, ensuring that the original NFT is burned (deactivated), and recording the transfer in the ledger of both blockchains, the owner can move his NFT from chain to chain, enjoying the advantages provided by the new blockchain, while still retaining proof of authenticity and provenance.

As disclosed herein, according to various embodiments, an owner of an existing NFT, stored on an original blockchain platform, transfers the NFT to a computing system's escrow wallet and instructs that the existing NFT be transferred to a secondary blockchain platform. The owner also pays a fee in order for the NFT to be transferred to the secondary blockchain platform. The system mints a new NFT to a system wallet on the second chain that was identified by the owner, where the minting uses data from the existing NFT. The system records a pointer to identify the existing NFT on the original blockchain platform, where the point may include a unique identifier which includes the chain, a contract address, and the token ID. In other embodiments, the pointer may include one or more of the chain, a contract address, and the token ID, combinations thereof, or other additional identifying information. Various combinations of information identifying the existing NFT are also contemplated herein.

Further, a transaction hash associated with the request to transfer the NFT is stored on the new NFT, and other data may also be stored to the new NFT. Further, the system simultaneously (a) burns the existing NFT that is stored on the original blockchain platform, and (b) records the burning transaction with a unique identifier (i.e., chain+contract address+tokenID) of the new NFT and also records the transaction hash of the minting transaction. According to various embodiments, if any steps in the NFT transfer transaction performed up until this point fail, the transfer transaction is reversed. Next, the system then transfers the new NFT to the owner's wallet on the secondary blockchain platform. If the system is unable to transfer the new NFT to the owner's wallet, the system may sleep and retry transferring the new NFT to the owner's wallet until it successfully transfers to the owner's wallet.

According to one alternative embodiment, if any component transaction of the NFT transfer transaction fail, the component transaction may be queued to be retried. However, if the component transaction that fails is a burn transaction to burn the existing NFT, the new NFT cannot be transferred to the owner's wallet until the burn transaction is completed.

The invention provides a host computer system for transacting Non-Fungible Tokens across a variety of blockchains. This system includes a processor, a network interface device connected to the processor, a computer readable medium connected to the processor, a data store on the computer readable medium and a set of instructions on the computer readable medium that are executable by the processor. The set of instructions includes transaction modules for each supported blockchain, a login module, a user module that establishes digital wallets in each blockchain desired by and registered to the owner of the NFT and a conversion module which executes the NFT owner's instructions for transfer.

The blockchain transaction modules enable the system to access digital wallets, as well as access and create transactions to mint, send and burn NFTs on that blockchain. A transaction module for Ethereum and a transaction module for Bitcoin Satoshi Vision (BSV) would enable the system to perform conversions between these two blockchains. The conversion module receives the NFT, collects the conversion fees, and executes the NFT owner instructions to transfer an NFT to a secondary blockchain platform. When using a distributed application, a login module receives credentials from a user's device over the network interface device to securely authenticate a user and prevent unauthorized access to the user module.

Following the completion of the conversion task (i.e., the transfer transaction), the host system has: (1) received the conversion fee from a funding digital wallet on the first blockchain provided by the NFT Owner; (2) received the target NFT from the owner to be converted; (3) minted a new NFT on the secondary blockchain platform, copying over the originating NFT's on-chain details to the newly minted NFT; (4) recorded the last transaction hash and blockchain details of the originating NFT onto the new minting transaction as an additional output; and (5) burned the originating NFT and recorded the minting transaction hash and new blockchain details as an additional output of the burning transaction; and (6) transferred the new NFT to the owner's digital wallet on the secondary blockchain platform.

The owner now owns a new version of the NFT on the secondary blockchain platform, only one active instance of the NFT exists on any blockchain and a clear ledger exists showing the provenance of the NFT from its original first minting, to its current state in the owner's digital wallet on the secondary blockchain platform.

As described herein, a digital wallet may be a separate application installed by the user on a user device where the user may add wallets, essentially private keys, which are represented by addresses. As contemplated herein, according to one embodiment, a distributed application may connect to one or more of the user's digital walls stored on the separate application in order to retrieve the blockchain reference and address of the existing NFT and in order to retrieve the blockchain reference and address where the NFT is to be transferred (i.e., where a new NFT is to be minted). Typically, a user would have a digital wallet application and create a wallet for each blockchain with which the user interacts. Thus, in order to perform a transfer transaction, the system contacts the respective wallet application to access the user's digital wallet that corresponds to the blockchain identified by the transfer request. When the system contacts the respective wallet application, a message may be displayed, via a user interface on the user device, for the user to confirm and approve (e.g., sign) thereby giving consent for the transfer transaction. In particular, the user signs for the escrow transfer and to pay the fees associated with the request. This user approval also provides consent to perform the burn transaction on the blockchain (original blockchain platform) that was associated with that user's digital wallet. A system wallet, rather than a user's digital wallet, may be used for the mint transaction as well as the transfer transaction itself, in which case the system signs (approves of or consents to) the transaction. In an alternative embodiment, the user may sign up front for all transactions associated with the transfer of the NFT.

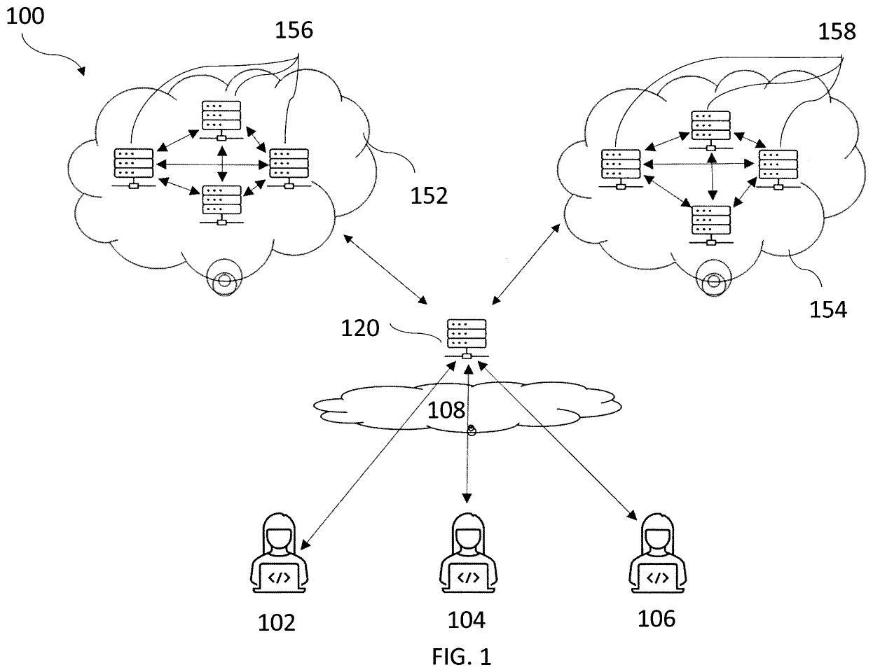

FIG. 1 depicts an example computing environment 100 that includes two blockchain node networks 152, 154, according to an implementation of the present disclosure. Also depicted is a first host computer system 120 (which could be one of many), and user devices 102, 104, 106, which connect to the host computer system(s) 120 via the internet 108. The first host computer system(s) 120 connect with the blockchain nodes 156 and 158 considered the host nodes of the respective blockchain node networks 152, 154. Each respective node 156, 158 in the blockchain networks 152, 154 is interconnected to several other nodes of that respective blockchain node network 152, 154, forming a fault-tolerant peer-to-peer network. Should a host node become unavailable, the host computer system 120 would connect to an alternate node within the blockchain network 152, 154.

Various embodiments of the present system 120 can be implemented within computing environment 100. According to one embodiment, system 120 may include various computing devices or a singular host computing device. By way of example, host system 120 may act as a data source that executes program code that transmits data to any number of computing devices 102, 104, 106.

As illustrated, computing device 102, computing device 104, and computing device 106 are different computing devices that may be in communication across one or more network(s) 108. For example, the network(s) 108 may be wired or wireless and may include a telecommunications network, a local area network (LAN), a wide area network (WAN) such as the Internet, or a combination thereof. Further, the network(s) are capable of transmitting data that can be received by one or more of the various computing devices 102, 104, 106.

Computing device(s) 102, 104, 106 may execute program code that is configured to perform methods in accordance with one or more aspects of the present invention. The various computing devices 102, 104, 106 may include one or more processors (e.g., central processing units CPUs) and various functional components to integrate program code by fetching, decoding, and executing the program code. The various computing devices 102, 104, 106 can include memory, input/output, a network interface, storage, and other computing components, that can be coupled to each other via one or more buses and/or other connections. According to various embodiments, the computing devices 102, 104, 106 may include or be associated with specific e-commerce websites, organizational websites, software applications, etc. that provide capabilities for initiating the transactions disclosed herein. Examples of computing devices include, but are not limited to, smartphones, tablet computer devices, laptop computing devices, personal computing devices, smart televisions, gaming consoles, and the like.

The host system 120 may include one or more graphical user interface accessible via the computing devices 102, 104, 106 that may allow a user to offer items (e.g., NFTs) for sale and or purchase, e.g. using cryptocurrency and/or a credit card, items (e.g., NFTs). According to some embodiments, the system 120 includes an application programming interface (API) system that expose APIs to one or more related applications or third party systems that are supported by or otherwise interact with the system 120. Further, an API system may push data to subscribing devices or systems and may include any suitable type of API, e.g., REST, SOAP, etc. As contemplated herein, the API system may include a smart contract API that allows smart contracts to interface.

In various embodiments, the system 120 may support a digital wallet that stores tokens owned by a user. Various embodiments of the system 120 may include intelligence and automation functionalities that perform machine learning and artificial intelligence tasks to train machine learned models, make classifications and predictions, recommend products to users, etc. Various embodiments may incorporate analytics reporting to facilitate improvements to the system 120.

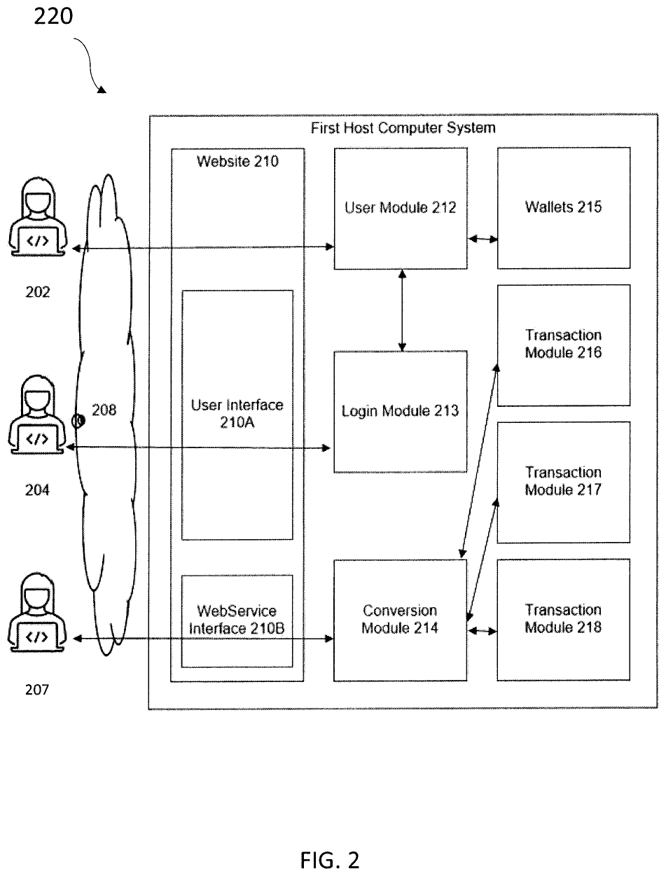

FIG. 2 depicts a block diagram of an example computing system 220 for secure data replication and original destruction using a blockchain distributed ledger, according to an implementation of the present disclosure. The computing system 220 of FIG. 2 may, according to various embodiments, be included in host computing system 120 depicted in FIG. 1.

Referencing computing system 220, included therein is a website 210 that includes a user interface 210A and a web service interface 210B. A login module 213 and a user module 212 are associated with the website 210, where the user module 212 connects to a plurality of user wallets 215 associated therewith via the user's digital wallet application(s) installed on the user device 202, 204. Also depicted is a conversion module 214 that is associated with the website 210 and includes a number of transaction modules 216, 217, 218 that are each configured to connect to a specific blockchain, which enables the conversion module 214 to communicate with and transact with each supported blockchain. The web service interface 210B included in website 210 allows a third party host computer system 207 to programmatically initiate a transfer, using a set of software instructions on its host computer system 220 to invoke actions such as, for example, provisioning a new user. In particular, the host computer system 207 may assign an escrow account to receive the NFT, where the escrow account may be segregated to the user or may be a community escrow account that performs many transactions. In accordance with implementations of the present disclosure, the host computing system 220 is transactional and would not retain the user's NFT or the cryptocurrency used as part of a sale after the transfer process is complete. Further, the user devices 202, 204 connect to the website 210 over the internet 208. Once the website 210 has been accessed, the user interface 210A is used to access the login module 23 and log-in to the website 210, thereby allowing a user to gain access to the host user system 220. Upon a successful authentication, the user devices 202, 204 can then connect to the user module 212 or conversion module 214 to perform the desired functionalities.

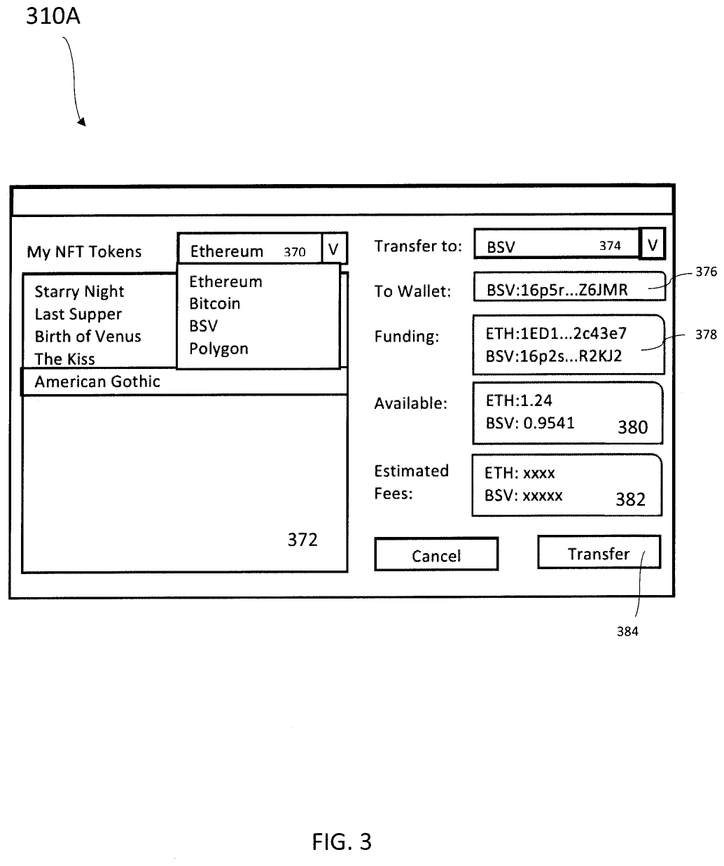

FIG. 3 depicts an example user interface 310A visible via a computing device (such as user devices 202, 204 referenced in FIG. 2), according to an implementation of the present disclosure. The example user interface 310A that is depicted is accessible once a user has successfully logged in and connected to the conversion module (see conversion module 214 of FIG. 2). Upon selecting a source blockchain 370, as depicted an Ethereum chain, the system (such as the first host computer system 220 of FIG. 2) finds all NFTs held by the wallet associated with the source blockchain 370, which a user may have previously uploaded to a digital wallet application. Once all NFTs are located, the user interface 310A displays the NFTs and the user may select one of the displayed NFTs to be transferred. In this particular example, the American Gothic NFT 372 is to be converted from the Ethereum blockchain to the Bitcoin Satoshi Vision (BSV) blockchain 374 and transferred to a corresponding BSV account wallet 376 that the user has registered in a BSV digital wallet application and has retrieved via user interface 310A. Additionally, the Ethereum and BSV funding accounts 378 maintained by this particular user in the user's digital wallet application are shown, and the cryptocurrency account balances 380 that the user has available for these respective accounts may be displayed. The associated fees for minting the American Gothic NFT 372 onto the BSV blockchain and burning the American Gothic NFT 372 on the Ethereum blockchain are also displayed. If the cryptocurrency account balances 380 are sufficient to meet the estimated fees 382 to mint the American Gothic NFT 372 onto the BSV blockchain, and burn the American Gothic NFT 372 on the Ethereum blockchain, then the Transfer button 384 becomes actionable for the user to provide the input to instruct the host computer system (such as the first host computer system 220 of FIG. 2) to start the minting and burning procedures. If a user decides not to effectuate the transaction, the user may also cancel the transaction.

As depicted, a user can have a plurality of funding accounts 378 (referred to as wallets 215 in FIG. 2) that can be selected from within a user module (such as user module 212 of FIG. 2). Specifically, one or more funding wallets 378 of the user on each respective blockchain will be required to facilitate payment the associated fees 382 for the minting and burning transactions. According to various embodiments, the funding wallet 378 may be the same wallet as the standard digital wallet 376 that is used to receive an NFT. According to one embodiment, a distributed web application (DAPP) connects to various supported blockchains, which would enable a user to add the one or more funding wallets 378 for each respective blockchain, but in particular the original blockchain platform and the secondary blockchain platform. The system provides an escrow wallet on the specified blockchain that is to receive the NFT that is to be transferred.

Alternatively, although not specifically depicted in FIG. 3, according to one embodiment a user can elect to provide a credit card to pay for the fees, in which case the conversion module reverts to using its own internal wallets to pay for the minting/burning fees, calculates the real dollar cost, and charges the user's credit card. This alternative embodiment may eliminate the need for funding wallets that are specific to each blockchain.

Also depicted in FIG. 3 is a plurality of NFT options that are displayed immediately above the American Gothic NFT 372. This plurality of NFT options has been identified by the system as being owned by the selected source blockchain and wallet and displayed as a possible candidate for transfer. Alternatively, the user may enter or submit a specific blockchain/contract address/tokenID combination representing a specific NFT. If the user is determined, by the system, to be the owner (meaning the user has the wallet address registered in the digital wallet application) the NFT is loaded and selected as the source NFT for the transfer.

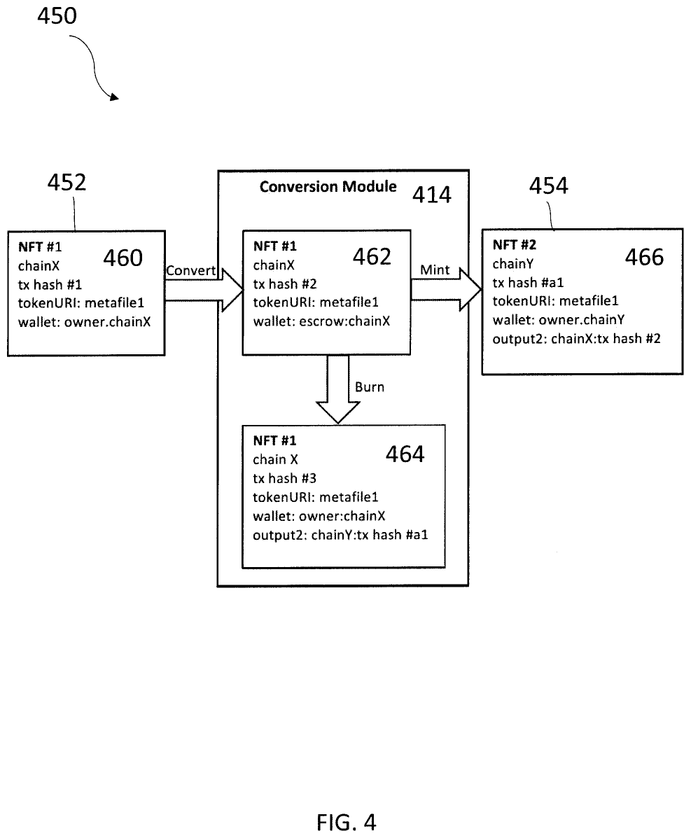

FIG. 4 depicts a block diagram of an example transaction 450 via a conversion module 414 (such as conversion module 214 of FIG. 2), according to an implementation of the present disclosure. As a general overview, FIG. 4 depicts an example where the owner of the NFT sends the NFT from the user's selected source blockchain/wallet and starts the transfer from the original blockchain platform 452 (e.g., blockchain X) to a secondary blockchain platform 454 (e.g., blockchain Y).

Specifically, the steps the first host computer system (such as the first host computer system 220 of FIG. 2) performs to transfer an NFT from an original blockchain platform 452 (e.g., blockchain X) to the secondary blockchain platform 454 (e.g., blockchain Y) are further depicted in FIG. 4. In this example, the conversion module 414 loads the originating NFT 460 (e.g., NFT #1) that was transferred by the user into the escrow wallet 462 owned by the first host computer system and that is accessible via the conversion module 414. Once loaded, the conversion module 414 copies the associated metadata, token URL and other NFT details. Using a smart contract on the secondary blockchain platform 454 (e.g., blockchain Y) that has similar functionality as a smart contract on the original blockchain platform 452 (e.g., blockchain X), the first host computer system (such as the first host computer system 220 of FIG. 2) mints a new NFT 466 (e.g., NFT #2), which includes replicating over NFT details that include associated metadata, token URL, and other NFT details. It is worth noting that this data identically replicated such that it is not modified, and the contents of token URL also remain identical. As part of the minting transaction, an additional transaction output (e.g., output2), as depicted with NFT 466, is created that stores the associated information of the originating NFT 460 (e.g., NFT #1) to uniquely identify the originating NFT (chain+contract address+tokenID) and final transaction hash (location) prior to the minting process (e.g., tx hash #2). With this data, anyone inspecting the provenance of the new NFT 466 (e.g., NFT #2) can see that the new NFT 466 (e.g., NFT #2) was derived from the originating 460 (e.g., NFT #1) on the original blockchain platform 452 (e.g., blockchain X). According to various embodiments, the new NFT 466 is minted with the owner's destination wallet on the secondary blockchain platform 454 (e.g., blockchain Y) or could be sent to the owner's destination wallet as a separate step. In various embodiments, the destination wallet could also be configured to be a buyer's wallet, if the owner was assured payment had been received.

Further, the originating NFT 460 (e.g., NFT #1) is subsequently burned 464 so that the existing/originating NFT 460 can no longer be used. As part of and simultaneous to that burning transaction, an additional output (e.g., output2) is created wherein the identifier of the secondary blockchain platform 454 (e.g., chainY), all details needed to uniquely identify the newly minted NFT (chain+contract address+tokenID), and the initial minting transaction hash (tx hash #a1) is stored. Once stored, anyone inspecting the existing/originating NFT 460 will be able to identify that this existing/originating NFT 460 was transferred at this point to the secondary blockchain 454 platform (e.g., blockchain Y) and can definitively locate and identify the new NFT 466 on the secondary blockchain platform 454 (e.g., blockchain Y). The transfer process is now complete.

In one particular embodiment, a reference blockchain may be used to store, via a transfer ledger contract, all transfers of the NFT. For instance, with respect to the reference blockchain, references to both the existing/originating NFT and to the new NFT (including the respective transaction hashes) are stored on the transfer ledger contract that tracks all transfers that occur. According to one embodiment, the reference blockchain includes a transfer ledger that is independent of an original ledger of the original blockchain platform and independent of a secondary ledger of the secondary blockchain platform. According to one embodiment, the reference blockchain may be on a same blockchain platform as either the original blockchain platform or the secondary blockchain platform, meaning the reference blockchain platform may be, for example, on BSV and it is possible that either the original blockchain platform or the secondary blockchain platform is also, for example BSV. Alternatively, it is also possible that the reference blockchain may be, for example, BSV but neither the original blockchain platform nor the secondary blockchain platform is, for example, BSV. According to one embodiment, the transfer process may further include recording the transfer transaction to the reference blockchain, where recording the transfer transaction includes storing references to both the existing NFT and the new NFT to a transfer ledger of a reference blockchain. In particular, the record of the transaction includes additional elements associated with the minting transaction and the burning transaction. The reference blockchain may also include various additional details associated with the transfer of the NFT.

Various non-limiting use examples are contemplated herein. For instance, in one example, Bob is an art-lover and purchased an NFT from his favorite artist Alice who only mints on BSV due to its low cost to mint. But the rest of his collection is on Ethereum and the app he uses to display his art on his large hallway TV only operates on Ethereum. Bob uses the conversion service to select his BSV wallet, which includes the NFT, as his source wallet, adds his personal Ethereum wallet to receive the converted NFT as well as paying for the minting, and adds his personal BSV wallet to pay for the burning fee. Once the transfer is complete, he sees the new NFT in his Ethereum wallet and is able to include it with his viewer app.

In another non-limiting example, Tom is a director of a museum and wants to mint NFTs of some of the museum's art collection. He elects to mint on BSV because his research has found it to be more climate friendly, and the low cost to mint is appealing to him. He mints his NFT's on BSV and proceeds to sell them on a BSV exchange. Mark purchases an NFT because he is very interested in the one-of-a-kind piece as an investment. Later, he decides to sell it, but believes Ethereum is the better vehicle for getting the best return. He uses the conversion service to perform the transfer to Ethereum and enters his credit card to pay for the service.

In an additional non-limiting example, Jane owns an NFT website and wants to give her customers the ability to perform these conversions. She adds the feature to her website, which uses the web service API that the conversion service makes available so that her website can configure users, wallets and initiate transfers programmatically, instead of using the conversion service's user interface.

In an additional non-limiting example, a first output from a first smart contract on a first blockchain can be transferred to a secondary blockchain platform where there is a comparable smart contract on the secondary blockchain platform that is able to read and perform some or all of the functions of the first contract using data copied from the first output. One example of this includes a cryptocurrency conversion contract where data could include ERC20 tokens (i.e., currency) or custom data.

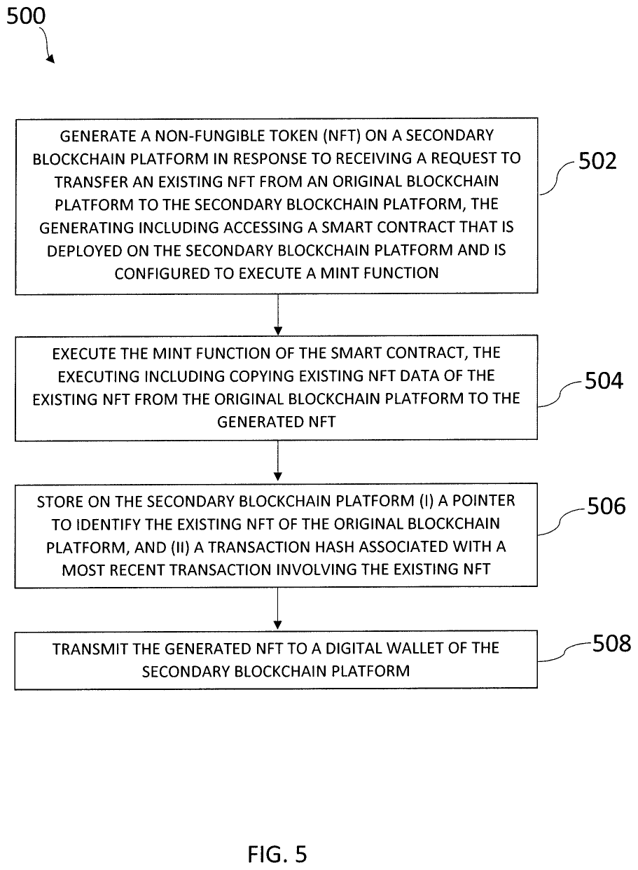

FIG. 5 depicts a flowchart of an example method 500 for secure data replication using a blockchain distributed ledger, according to an implementation of the present disclosure. More specifically, method 500 represents one example workflow for replicating secure data from an original blockchain platform to a secondary blockchain platform.

In step 502, a NFT is generated, by a computer system, on a new/secondary blockchain platform in response to that host computer system receiving request to transfer an existing NFT from an original blockchain platform (e.g., Ethereum) to the secondary blockchain platform (e.g., BSV). Generating the NFT may include accessing, by the computer system, a smart contract to execute a mint function. In one embodiment, accessing the smart contract may include deploying a smart contract if, for example, a smart contract does not already exist. According to one embodiment, the computing system may include a host computing system, and the host computing system may include one or more escrow accounts. In one particular example, the host computer system may include a third-party host computer system that is independently operated by a third party.

As contemplated herein, the original blockchain platform includes an original ledger that is distinct from a secondary ledger of the secondary blockchain platform. According to one embodiment, both the original blockchain platform and the secondary blockchain platform may be public blockchain platforms, but each blockchain may have its own cryptocurrency system or may have its own governing policies that are distinct from other public blockchain platforms. In another embodiment, the original blockchain platform and the secondary blockchain platform may be different types of blockchain platforms (e.g., public blockchain, private blockchain, consortium blockchain, hybrid blockchain, etc.).

Further, according to one embodiment, generating the NFT is based on receiving, from a user device, a request for a transfer of the existing NFT, and the existing NFT may be deposited into an escrow account that is accessible by the host computer system. Additionally, based on receiving the request for a transfer of the existing NFT, generating the NFT may also include, according to one embodiment, identifying the existing NFT in the escrow account.

In step 504, the mint function associated with the smart contract (having a specific contract address) that was deployed on the secondary blockchain platform is executed. Execution of the mint function includes copying existing NFT data of the existing NFT from the original blockchain platform to the generated NFT. According to one embodiment, the existing NFT data may include NFT metadata that includes one or more of royalty information, a unique location represented by a blockchain, a contract address, a token ID, a token URL pointing to the metadata, and/or documents attached to the NFT. In particular, the NFT metadata may include each and every one of the royalty information, a unique location represented by a blockchain, a contract address, a token ID, a token URL pointing to the metadata, and documents attached to the NFT. Alternatively, the NFT metadata may include only one of the royalty information, a unique location represented by a blockchain, a contract address, a token ID, a token URL pointing to the metadata, or documents attached to the NFT. In other embodiments, the NFT metadata may include two or more or other combinations of the royalty information, a unique location represented by a blockchain, a contract address, a token ID, a token URL pointing to the metadata, or documents attached to the NFT. Further, the mint function would create a new token ID for the new blockchain with the contract address of the smart contract of the new blockchain. According to one embodiment, executing the mint function includes creating a minting transaction hash identifying a successfully completed transaction.

In step 506, the host computer system stores both (i) a pointer to the original blockchain platform, and (ii) a transaction hash associated with the original/existing NFT on the secondary blockchain platform. According to one embodiment, the transaction hash associated with the original/existing NFT is the transaction hash associated with a most recent transaction involving the existing NFT—specifically transferring the existing NFT to the system escrow account. In particular, the method may include storing on the secondary blockchain platform a unique identifier of the existing NFT that is on the original blockchain platform, and storing a transaction hash associated with an escrow transfer of the existing NFT. According to one embodiment, the storing may further include storing the transfer transaction hash of the existing NFT on the secondary blockchain platform.

In step 508, the generated NFT is transmitted to a digital wallet of the secondary blockchain platform. According to one embodiment, transmitting the generated NFT is based on a burn function of the smart contract being invoked and verifiably completed. Once the burn function is invoked, according to one embodiment, the existing NFT is burned, where the burning includes permanently locking the existing NFT on either an unlockable blockchain wallet or null blockchain wallet on the original blockchain platform. According to one embodiment, the transaction that burns the existing NFT further includes recording a burning transaction on the original blockchain platform, wherein the recorded burning transaction includes (a) a reference to the newly minted NFT on the secondary blockchain platform, and (b) a minting transaction hash that is created when the mint function is executed. According to one embodiment, transmitting the generated NFT to the second digital wallet may be based on the existing NFT being verifiably burned such that the original NFT on the original blockchain platform has been destroyed, according to one embodiment.

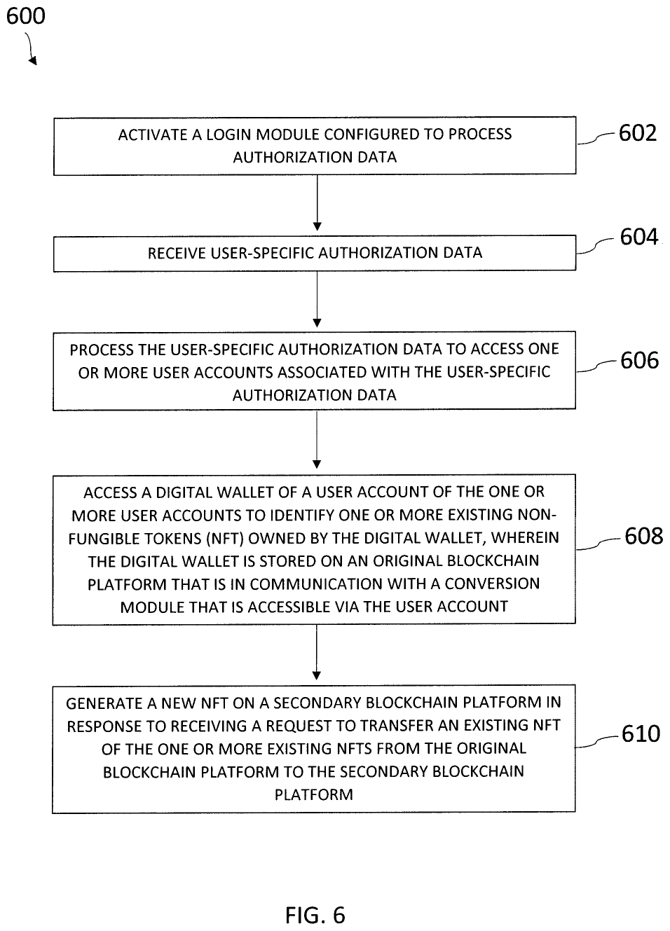

FIG. 6 depicts a flowchart of an example method 600 for processing user-specific authorization data for secure data replication and original destruction, according to an implementation of the present disclosure. In particular, the method 600 is performed via a computing system that includes a memory, one or more processors in communication with the memory, and program instructions executable, via the memory, by the one or more processors.

Step 602 includes activating a login module configured to process authorization data. In step 604, the computing system receives user-specific authorization data. In step 606, user-specific authorization data is processed to access one or more user accounts associated with the user-specific authorization data. In step 608, a digital wallet of a user account of the one or more user accounts is accessed to identify an existing NFT, wherein the digital wallet is stored on an original blockchain platform that is in communication with a conversion module that is accessible via the user account. In step 610, a NFT is generated on a secondary blockchain platform in response to receiving a request to transfer the existing NFT from the original blockchain platform to the secondary blockchain platform. According to one embodiment, the computing system includes a host computer system that includes one or more escrow accounts.

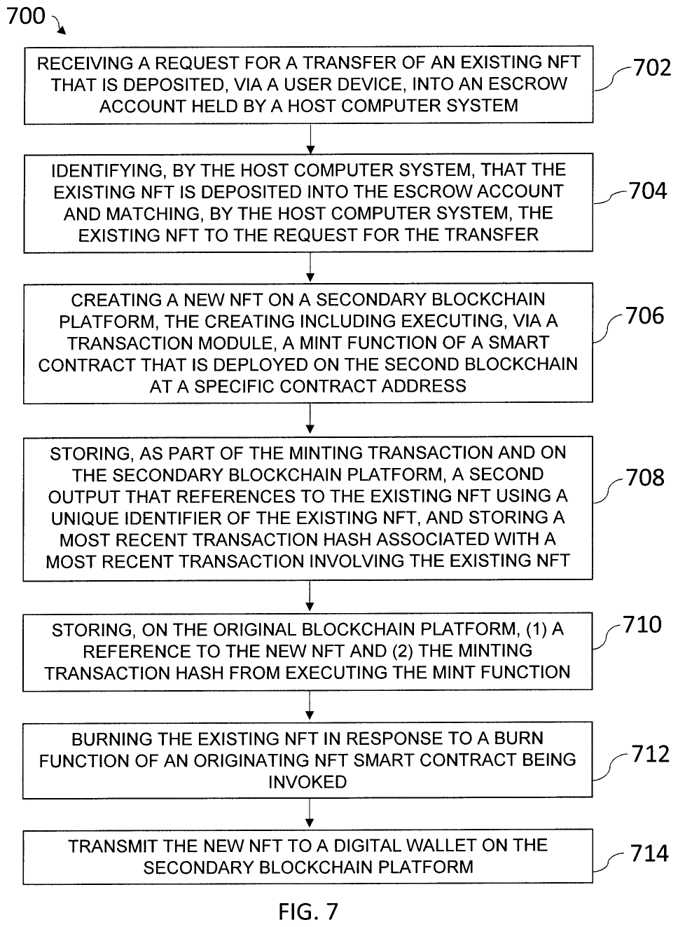

FIG. 7 depicts a flowchart of an example method 700 of transferring an existing/original NFT created on an original blockchain platform to a secondary blockchain platform, according to an implementation of the present disclosure. In step 702 a request is received for a transfer of an existing NFT that is deposited, via a user device, into an escrow account held by a host computer system. According to one embodiment, the request is received when the existing NFT is deposited into an escrow account accessible to the computing system as part of the same submission process. In step 704, the existing NFT that is deposited into the escrow account is identified by the host computer system and matched with the user's transfer request. In step 706, a new NFT is created on a secondary blockchain platform, where the creating includes executing, via a transaction module, a mint function of a smart contract that is deployed on the secondary blockchain platform at a specific contract address. In step 708, a second output is stored as part of the minting transaction and on the secondary blockchain platform, where the second output references to the existing/original NFT using a unique identifier (e.g., chain, contract address, and tokenID) of the existing/original NFT. Additionally, in step 708, a most recent transaction hash associated with a most recent transaction involving the existing/original NFT (i.e., the transfer to the escrow account) is also stored on the secondary blockchain platform. In step 710, both a reference to the new NFT and also the minting transaction hash from executing the mint function are stored on the original blockchain platform. In step 712, the existing/original NFT is burned in response to a burn function of an originating NFT smart contract being invoked. According to one embodiment, step 710 and step 712 are performed as part of a single transaction process such that step 710 and 712 are performed as part of the same transaction record, and identified by the same transaction hash. In step 714, after completion of the original NFT burn, the new NFT is transmitted to a digital wallet on the secondary blockchain platform.

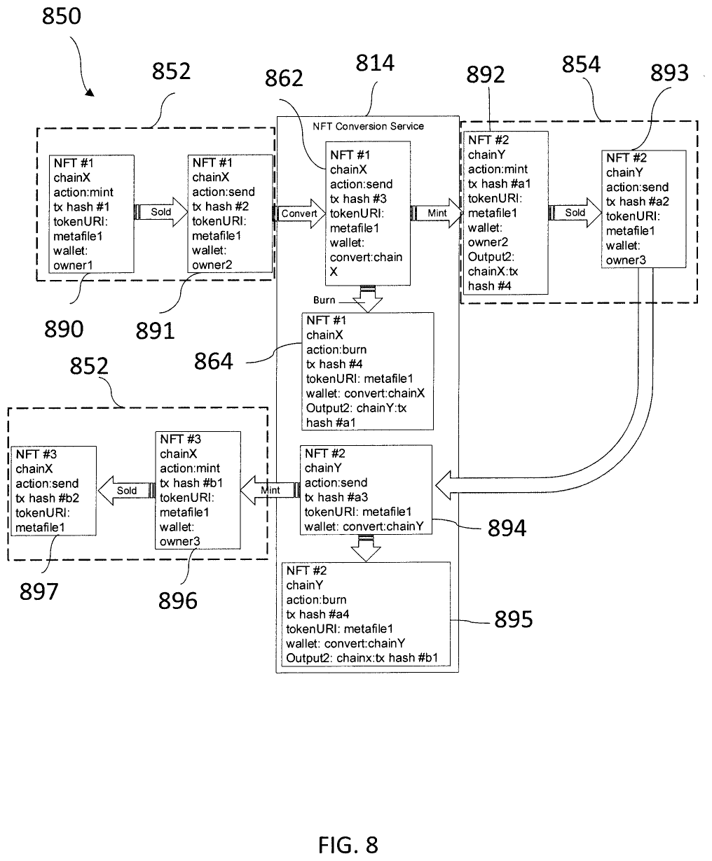

FIG. 8 depicts a block diagram 850 of an example transaction via a conversion module 814 of a third-party NFT conversion service, according to an implementation of the present disclosure. As a general overview, the process flow depicted by the block diagram 850 allows a user to create an account on the third-party NFT conversion service and request a conversion from an original blockchain platform 852 (e.g., blockchain X) to a secondary blockchain platform 854 (e.g., blockchain Y). Further, the user may be required to pay a fee for the conversion process performed via the third-party NFT conversion service. The third-party conversion service may provide a user with an escrow wallet on the original blockchain platform 852 (e.g., blockchain X) where the user can send the NFT that the user wishes to convert to the secondary blockchain platform 854 (e.g., blockchain Y). Once the user uploads the NFT to the wallet such that the third-party conversion service receives the NFT on the original blockchain platform 852, the service mints a new NFT on the secondary blockchain platform (e.g., blockchain Y), which includes copying the details from the NFT that was received from the user. The details that are copied include the token URL.

Additionally, the third-party conversion service provides, via the minting transaction, an additional output, which includes data identifying the original NFT (e.g., NFT located at blockchain X, contract address X, tokenID X) and an associated receiving transaction hash. Also, the third-party conversion service may burn the original NFT that was received and includes along with the burning transaction additional data in the second output of the burning transaction, identifying the newly minted NFT (e.g., blockchain Y, contract address Y and tokenID Y) and the minting transaction hash. The third-party service may set the owner of the new NFT, or may send the new NFT to the wallet of the secondary blockchain platform 854 (e.g., blockchain Y) that corresponds to the owner that requests the conversion. Thus, the owner receives the newly minted NFT in a second wallet located on the secondary blockchain platform 854 (e.g., blockchain Y).

In particular an existing NFT 890 is minted such that it is stored in an owner's account on the original blockchain platform 852. A sale of the existing NFT 890 to another owner on the first blockchain 852 retains the same existing NFT 891 but now includes a transaction hash (hash #2) associated with the existing NFT 891 to be stored on the original blockchain platform 852. The new owner, which may be a third party conversion service, may run the existing NFT 891 through the conversion module to produce a new NFT 862 (NFT #2), which includes another transaction hash (hash #3) representing the minting transacting on a secondary blockchain platform 854. As a result, after the asset passes through the conversion module 814 of the new owner (e.g., the conversion service), a new NFT 892 (NFT #2) is minted onto the secondary blockchain platform 854. Once located on the secondary blockchain platform 854, the new NFT 892 may be transferred to the desired owner such that the asset includes a new NFT 893 having an associated hash (hash #a2). Additionally, the existing NFT 862 (NFT #1) may be burned to create a burned NFT 864 having an associated hash (hash #a1) associated therewith.

A user may subsequently desire to transfer the asset back to the original blockchain platform 852, and the asset may pass back through the conversion module 814 using the new NFT 894. The new NFT 894 may then be minted to the original blockchain platform 852 as replaced NFT 896 having an additional hash (e.g., hash #b1). Once minted, the replaced NFT 896 may be sold as a recently sold NFT 897. Further, the new NFT 894 may be burned to produce a burned NFT 895.

To enable various functionalities described herein, a distributed application (e.g., MonaDAPP) may be used to facilitate the creation of portfolio NFTs that would be compatible with major NFT exchanges. In particular, the distributed application that performs the processes disclosed herein may support, for example, Ethereum, Polygon, BSV, and Solana. Further, the distributed application may be integrated with one or more of the major wallet applications that correspond to each chain such as, for example, Metamask (Ethereum & Polygon), HandWallet (BSV), TempleWallet (Tezos), and Phantom wallet (Solana).

Various functionalities may be enabled via the distributed application. For instance, one example functionality may encrypt content on a specific peer-to-peer network (e.g., InterPlanetary File System (IPFS)) via a unique per-NFT symmetric key (e.g., an AES key) that is encrypted with a document private key and linked to an NFT stored on the blockchain. Further functionalities may implement an NFT lock/unlock mechanism that would enable successful transfer of an encrypted NFT and the unique per-NFT encryption key (e.g., AES key). Another functionality may provide a Key Claim mechanism for a new owner of a Portfolio NFT to claim the NFT encryption key and successfully decrypt a newly purchased NFT. Further, multi-content NFTs may be created on the specific peer-to-peer network (e.g., InterPlanetary File System (IPFS)) by utilizing ERC-721 metadata.json standard on a user-specified chain.

The application also supports “lazy-minting,” where the minting occurs at the moment of purchase, which can be performed in association with redeemable signed vouchers. Specifically, the application may support (a) Rarible and/or Opensea lazy-mint mechanisms, (b) Interim, which allows for purchases of vouches via a wallet and allows a user to determine a price, (c) mint token, when enables vouchers to be redeemable by the owner or buyer, and (d) target Wallet fee calculation and deduction for minting, where the minting process would fail if the available funds are insufficient.

Another functionality that may be supported by the distributed application is support for royalties that are associated with specific NFTs. In particular, to support royalties on Ethereum Virtual Machine (EVM) chains, a Rarible IRoyaltiesProvider interface may be used. In another example, support for Opensea royalties may be implemented using the EIP2981 royalty standard. Additional royalty support functionalities are also contemplated herein including, for example, support for EVM royalty information to be transferred to non-EVM chains.

An example server that may be utilized, for example, by the distributed application (e.g., MonaDAPP) is a nodeJS server (e.g., MonaServer) that performs the new owner key claim functionality. According to one embodiment, the server may receive a request from the distributed application (e.g., MonaDAPP) for KeyClaim, where the request includes various parameters including, for example, a tokenID, a signed verification message, an unlock key, contract.address, and the network identified (multi-chain). The server may return keydata for Mona-DAPP to complete the key exchange. The server may also, according to one embodiment, retrieve unlock and owner data from the respective blockchain, which may eliminate the need for multi-chain access since all data can be obtained from the distributed application (e.g., MonaDAPP) while ensuring data protection and authenticity.

Various example smart contracts may also be used to perform the processes disclosed herein. According to one embodiment, each blockchain may implement an ERC-721 functional equivalent for that respective blockchain. In one particular example, various functions will be implemented, which at a minimum include: mint, transferFrom, burn, ownerOf, and tokenURI.

The disclosed processes include functionalities that may be incorporated by using a multi-verse play (MVP) NFT asset management platform that includes a progressive web application (PWA) where a user may import a wallet for numerous blockchains using third-party wallets (e.g., metamask, phantom, etc.). An example MVP implementation may include retrieving, via the PWA, an NFT attached to the user's wallet(s) and displaying the NFT. A user may select and open the displayed NFT (e.g., by clicking a transfer button) and select from a list of configured blockchains into which the NFT can be ported. According to one embodiment, the list of configured blockchains may be limited to blockchains that already have configured wallets belonging to the user. Additionally, the PWA choreographs the porting sequence and enables the user to approve the mint and burn requests. The MVP implementation may also queue signed transactions so that the transaction is not executed until all transactions have been signed. Lastly, a burn transaction is executed. According to various embodiments that incorporate the MVP implementation, all signed transactions may be atomically executed. Additionally, the server may record various data in a bridging contract, where the data includes, for example, “from” and “to” data (e.g., contract address(es), tokenID, chain, wallet address, royalty data, etc.) and timestamp data.

Also contemplated herein are processes for the MVP implementation to handle royalties. In particular, original royalty recipient(s) should be entitled to receive royalties from the sale of ported NFTs even if the NFT has been replicated across several blockchains. To facilitate records for royalty payments, the original royalty payment percentages and associated terms are copied to the new NFT. Further, one or more proxy wallets may be created on the new blockchain and may be designated as the recipient of the royalty payment(s). Royalties may be transferred, based on a sale, to one or more of the proxy wallets that are created, where the royalty payment(s) may be transferred in the form of wrapped cryptocurrency and further transferred to a root royalty wallet that may be identified in the bridging contract for the NFT.

Aspects of the present invention are described herein with reference to flowchart illustrations and/or block diagrams of computer-implemented methods and computing systems according to embodiments of the invention. It will be understood that each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus. The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A computing system for secure data replication and original destruction using a blockchain distributed ledger, the system comprising:
a memory;
one or more processors in communication with the memory; and
program instructions executable by the one or more processors via the memory to:
generate a non-fungible token (NFT) on a secondary blockchain platform in response to receiving a request to transfer an existing NFT from an original blockchain platform to the secondary blockchain platform, the generating including accessing a smart contract that is deployed on the secondary blockchain platform and is configured to execute a mint function;
execute the mint function of the smart contract, the executing including copying existing NFT data of the existing NFT from the original blockchain platform to the generated NFT;
store on the secondary blockchain platform (i) a pointer to identify the existing NFT of the original blockchain platform, and (ii) a transaction hash associated with a most recent transaction involving the existing NFT; and
transmit the generated NFT to a digital wallet of the secondary blockchain platform.

2. The computing system of claim 1, wherein the original blockchain platform comprises an original ledger distinct from a secondary ledger of the secondary blockchain platform.

3. The computing system of claim 1, wherein the generating the NFT is based on receiving, from a user device, a request for a transfer of the existing NFT to the secondary blockchain platform.

4. The computing system of claim 3, wherein with the receiving of the request, the existing NFT is deposited into an escrow account accessible to the computing system.

5. The computing system of claim 4, wherein based on receiving the request for the transfer of the existing NFT the generating includes identifying the existing NFT in the escrow account and associating the existing NFT with the request for the transfer.

6. The computing system of claim 1, wherein the existing NFT data includes NFT metadata that includes one or more of royalty information, a unique location represented by a blockchain, a contract address and a token ID, a token URL pointing to the metadata, and/or documents attached to the NFT.

7. The computing system of claim 1, wherein the computing system includes a host computer system that includes one or more escrow accounts.

8. The computing system of claim 7, wherein the host computer system is independently operated by a third-party conversion service.

9. The computing system of claim 1, wherein the transmitting the generated NFT is based on a burn function of the smart contract being invoked, the invoking facilitating a burning transaction that includes burning the existing NFT and recording the burning on a the original blockchain platform, and receiving a new transaction hash confirming completion of the burning transaction.

10. The computing system of claim 9, wherein based on the burn function being invoked, the existing NFT is burned, wherein the burning includes permanently locking the existing NFT on either an unlockable blockchain wallet or a null blockchain wallet on the original blockchain platform.

11. The computing system of claim 10, wherein the burning further includes recording the burning transaction on the original blockchain platform, wherein the recorded burning transaction includes (a) a unique identifier of the generated NFT on the secondary blockchain platform, and (b) a minting transaction hash that is returned when the mint function is executed on the secondary blockchain platform.

12. The computing system of claim 11, wherein the burning further includes recording, via a transfer ledger smart contract, both a burning transaction and a mint transaction to a reference blockchain.

13. The computing system of claim 12, wherein the reference blockchain includes a transfer ledger that is independent of an original ledger of the original blockchain platform and independent of a secondary ledger of the secondary blockchain platform.

14. The computing system of claim 1, wherein the most recent transaction that is associated with the stored transaction hash identifies a transfer transaction of the existing NFT to a system escrow account on the secondary blockchain platform.

15. The computing system of claim 1, wherein the storing further includes storing a unique identifier of the existing NFT on the secondary blockchain platform.

16. The computing system of claim 1, wherein the transmitting the generated NFT is based on the existing NFT being verifiably burned.

17. A computing system for secure data replication and original destruction using a blockchain distributed ledger, the system comprising:
a memory;
one or more processors in communication with the memory; and
program instructions executable by the one or more processors via the memory to:
activate a login module configured to process authorization data;
receive user-specific authorization data;
process the user-specific authorization data to access one or more user accounts associated with the user-specific authorization data;
access a digital wallet of a user account of the one or more user accounts to identify one or more existing non-fungible tokens (NFT) owned by the digital wallet, wherein the digital wallet is stored on an original blockchain platform that is in communication with a conversion module that is accessible via the user account; and
generate a new NFT on a secondary blockchain platform in response to receiving a request to transfer an existing NFT of the one or more existing NFTs from the original blockchain platform to the secondary blockchain platform.

18. The computing system of claim 17, wherein the computing system includes a host computer system that includes one or more escrow accounts.

19. A computer-implemented method for secure data replication and original destruction using a blockchain distributed ledger, the computer-implemented method comprising:
generating a non-fungible token (NFT) on a secondary blockchain platform in response to receiving a request to transfer an existing NFT from an original blockchain platform to the secondary blockchain platform, the generating including accessing a smart contract that is deployed on the secondary blockchain platform and is configured to execute a mint function;
executing the mint function of the smart contract, the executing including copying existing NFT data of the existing NFT from the original blockchain platform to the generated NFT;
storing on the secondary blockchain platform (i) a unique identifier of the existing NFT that is on the original blockchain platform, and (ii) a transaction hash associated with an escrow transfer of the existing NFT; and
transmitting the generated NFT to a digital wallet of the secondary blockchain platform.

20. The computer-implemented method of claim 19, further comprising:
burning the existing NFT, wherein the burning includes permanently locking the existing NFT on either an unlockable blockchain wallet or a null blockchain wallet on the original blockchain platform; and
recording, on the original blockchain platform, a unique NFT identifier of the generated NFT and an associated generating-transaction hash;
wherein the burning and the recording occur as part of a same transaction process.
